(19) United States
(12) Patent Application Publication
(10) Pub. No.: US 2026/0056777 A1
(43) Pub. Date: Feb. 26, 2026

(54) METHODS, SYSTEMS, ARTICLES OF MANUFACTURE AND APPARATUS TO SYNCHRONIZE TASKS

(71) Applicant: Intel Corporation, Santa Clara, CA (US)

(72) Inventors: Zhigang Wang, Beijing (CN); Hai Tao Wang, Shanghai (CN); Yingzhe Shen, Beijing (CN)

(73) Assignee: Intel Corporation, Santa Clara, CA (US)

(21) Appl. No.: 18/998,892

(22) PCT Filed: Sep. 29, 2022
(86) PCT No.: PCT/CN2022/122691

§ 371 Date: Jan. 27, 2025

(51) Int. Cl. G06F 9/48; G06F 3/01; G06V 10/20

(52) U.S. Cl. CPC G06F 9/4881; G06F 3/011; G06V 10/255

(57) ABSTRACT

Methods, apparatus, systems, and articles of manufacture are disclosed to synchronize tasks. An example apparatus to synchronize tasks includes at least one memory, machine readable instructions, and processor circuitry to at least one of instantiate or execute the machine readable instructions to identify a first task frequency associated with a first task, the first task executed by the computing device, the first task outputting first data at first times, identify a second task frequency associated with a second task, the second task executed by the computing device, the second task outputting second data at second times, when the second task frequency is different from the first task frequency, calculate a first difference between the second task frequency and the first task frequency, and adjust at least one of the first task frequency or the second task frequency based on the first difference such that the second times match the first times.

### FIELD OF THE DISCLOSURE

This disclosure relates generally to application tasks and, more particularly, to methods, systems, articles of manufacture and apparatus to synchronize tasks.

### BACKGROUND

Computing platforms can communicate with one or more processing units to execute instructions to perform one or more computing tasks. Each of the processing units may execute tasks in a manner independent of any other processing unit in an effort to satisfy one or more task objectives. In some time-sensitive applications, such as robotics and/or autonomous vehicles, task synchronization tools can be deployed to adjust the manner of task execution.

### BRIEF DESCRIPTION OF THE DRAWINGS

FIG. 1 illustrates an example system constructed in accordance with teachings of this disclosure.

FIG. 2 is a block diagram of example synchronization circuitry included in the system of FIG. 1.

FIG. 3 illustrates an example process flow that may be used to implement the system of FIG. 1.

FIG. 4 illustrates an example process flow to synchronize tasks.

FIG. 5 illustrates another example process flow to synchronize tasks.

FIG. 6 illustrates yet another example process flow to synchronize tasks.

FIG. 7 is a flowchart representative of example machine readable instructions and/or example operations that may be executed by example processor circuitry to implement the example synchronization circuitry of FIG. 2.

FIG. 8 is a flowchart representative of example machine readable instructions and/or example operations that may be executed by example processor circuitry to implement the example synchronization circuitry of FIG. 2.

FIG. 9 is a block diagram of an example processing platform including processor circuitry structured to execute the example machine readable instructions and/or the example operations of FIGS. 7 and 8 to implement the example synchronization circuitry of FIG. 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 7 and 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time”refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Some computing platforms utilize concurrent (e.g., parallel) processing (e.g., two or more computing devices that execute at substantially the same time, two or more programming threads that execute at substantially the same time, etc.) for task execution across multiple devices, processors, etc. For example, a computing platform including a central processing unit (CPU) and a graphics processing unit (GPU) can utilize concurrent programming to facilitate simultaneous use of the CPU (and/or one or more cores therein) and the GPU. In some examples, concurrent programming can be implemented in publish-subscribe frameworks. In some examples, publish-subscribe frameworks provide two basic interfaces, publish and subscribe, to help developers to transport messages between programs and/or between devices. When a developer calls the publish interface (e.g., an application programming interface (API)), the message will be added into a message queue. Accordingly, the subscribe interface will check the message queue and call a registered call back function if there is any message available in the message queue. In such cases, software developers may only need to focus on the development of the message processing logic, rather than the details of message passing. As developments in artificial intelligence (AI) advance, synchronization between devices and/or programs can become advantageous. Generally speaking, two or more devices and/or program threads may operate (e.g., execute) to perform one or more tasks (e.g., sub-tasks, objectives, algorithms, containers, threads, routines, messages, devices, communications, etc.). In the event a task involves safety (e.g., a manufacturing environment), then a first device may need to have synchronized communication with a second device so that the tasks operate in a manner that promotes safety. As used herein, “synchronized communications”, “synchronized tasks”, “synchronized messages”, “synchronized devices”, “synchronized programs”, etc. refer to at least two tasks (e.g., sub-tasks (e.g., tasks that are instantiated by an antecedent task), objectives, algorithms, containers, threads, routines, messages, devices, communications, etc.) that output data at substantially (e.g., within 0.2 seconds) the same frequency. In other words, synchronized tasks include at least a first task that outputs data at a first frequency and a second task that outputs data at a second frequency, wherein the first frequency and the second frequency are substantially the same. As used herein, “unsynchronized communications”, “unsynchronized tasks”, “unsynchronized messages”, “unsynchronized devices”, “unsynchronized programs”, etc. refer to at least two tasks that output data at different frequencies. In other words, unsynchronized tasks include at least a first task that outputs data at a first frequency and a second task that outputs data at a second frequency, wherein the first frequency is different from the second frequency.

In some examples, autonomous vehicles can include devices and/or program threads that may need to have synchronized communications. For example, an autonomous vehicle may have sensors for detecting objects (e.g., people, hazards, cars, etc.). Object sensors in autonomous vehicles may need to have synchronized communication with alert notification systems and/or braking mechanisms to avoid accidents and/or collisions. In other examples, devices involved in robotic surgery may need to have synchronized communications. For example, devices involved in robotic surgery can include a control system operated by a surgeon and surgical tools (e.g., surgical staplers, surgical forceps, etc.). Surgical tools involved in robotic surgery may need to have synchronized communication with the control system operated by a surgeon such that the surgical tools operate in a manner consistent with the surgeon's commands and/or inputs. In such cases, synchronized communication between devices involved in robotic surgery can ensure patient safety, surgeon safety, etc.

One approach to improve synchronization between devices, programs, and/or messages includes filtering out unsynchronized messages. However, this approach requires manual supervision such as tuning a queue depth and manually adjusting the frequency of the task execution to ensure synchronization across devices. Further, this approach filters (e.g., deletes) unsynchronized messages and data included in the unsynchronized messages. Accordingly, the data management and power that the program(s) and/or device(s) utilizes to generate the unsynchronized messages is wasted (e.g., filtered out, deleted, etc.).

Examples disclosed herein synchronize input message streams between devices (e.g., computing devices, Internet of Things (IoT) devices, processors, processor cores, etc.) and/or software programs (e.g., code, multi-threaded code, etc.). Examples disclosed herein monitor, parse, examine and/or otherwise evaluate messages (e.g., message headers) for timestamp information (e.g., timestamps, time information, date information, etc.) and/or sequential identifiers (IDs) to synchronize messages. Examples disclosed herein adjust frequencies associated with messages, devices, programs, etc. As such, examples disclosed herein improve data management and power management of devices, software programs, AI systems, etc.

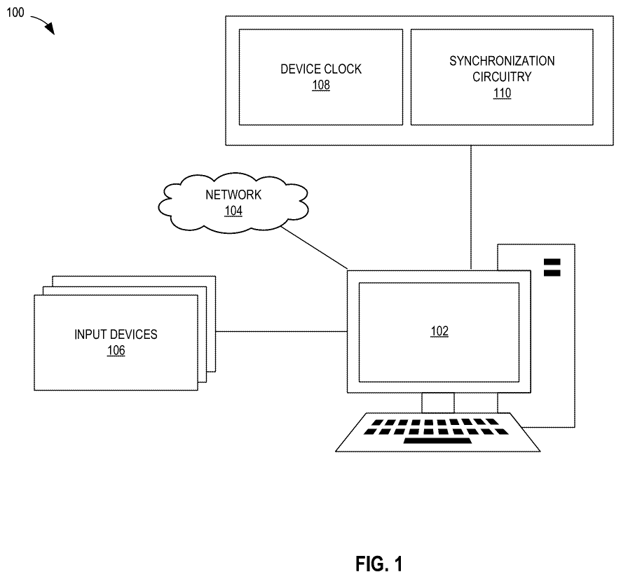

FIG. 1 illustrates an example system 100 constructed in accordance with teachings of this disclosure. The system 100 includes an example computing device 102, an example network 104, and example input devices 106. The example computing device 102, which may also be referred to as the example computing device 102, includes an example clock 108 and example synchronization circuitry 110. In this example, the computing device 102 is implemented as a desktop computer. However, in other examples, the computing device 102 can be implemented by any other type of electronic device, such as a smartphone, a tablet, a laptop computer, a game console, etc.

In the illustrated example of FIG. 1, the example system 100 includes input devices 106. In some examples, the input devices 106 can include a camera, a microphone, movement sensors, etc. In other examples, the input devices 106 include any kind of input device such as audio devices, video devices, recording devices, etc. In some examples, the input devices 106 include sensors (e.g., Virtual Reality (VR) sensors, gyroscopes, external sensors, motion sensors). In some examples, the input devices 106 include self-driving sensor devices (e.g., radar cameras, depth cameras, etc.). The input devices 106 can by physically connected (e.g., via one or more wires or cables) and/or integral to the computing device 102. In some examples, the input devices 106 are discrete devices that are separate from the computing device 102.

The example network 104 can be implemented by any suitable wired and/or wireless network(s) including, for example, one or more data buses, one or more Local Area Networks (LANs), one or more wireless LANS, one or more cellular networks, one or more public networks, etc. The example network 104 enables transmission of data (e.g., audio data) between the computing device 102 and the input devices 106 of the system 100.

In FIG. 1, the computing device 102 includes the example clock 108 and the example synchronization circuitry 110. In this example, the synchronization circuitry 110 is implemented on the computing device 102. The example computing device 102 can include any number and/or type of processing circuitry that execute instructions according to a clock rate (e.g., pulses from the clock 108). In some examples, the synchronization circuitry 110 adjusts a trigger frequency (e.g., frequency, rate of pulses, etc.) of the clock 108. Additionally or alternatively, in some examples, the synchronization circuitry 110 synchronizes pulses (e.g., triggers, messages, etc.) associated with application threads, software programs, publish-subscribe frameworks, etc. of the example input devices 106, example computing device 102, and/or any other systems associated with the computing device 102. In some examples, a first task is executed by a graphics processing unit (GPU) associated with the computing device 102 and a second task is executed by a video processing unit (VPU) associated with the computing device 102.

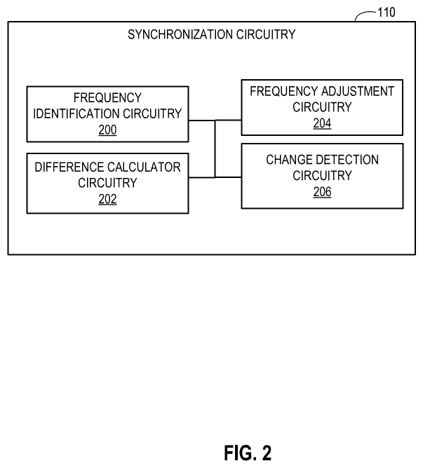

The example synchronization circuitry 110 can synchronize messages in a publish-subscribe framework, synchronize tasks associated with processing units, synchronize application threads associated with software, synchronize capture rates of the input devices 106, etc. Examples disclosed herein are described with human object interaction detection as example software implemented by the example computing device 102 and/or the example synchronization circuitry 110, but examples disclosed herein are not limited thereto. In other words, the example synchronization circuitry 110 and the example system 100 can implement any kind of software utilized by a computing device (e.g., robotic systems, autonomous vehicles, etc.). An example implementation of the synchronization circuitry 110 is described below in connection with FIG. 2.

FIG. 2 is a block diagram of the example synchronization circuitry 110 to synchronize tasks executed by a computing device. In some examples, the example synchronization circuitry 110 can synchronize tasks received by a computing device. The synchronization circuitry 110 of FIG. 2 may be instantiated (e.g., creating an instance of, bring into being for any length of time, materialize, implement, etc.) by processor circuitry such as a central processing unit executing instructions. Additionally or alternatively, the example synchronization circuitry 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The synchronization circuitry 110 of the example of FIGS. 1 and 2 includes example frequency identification circuitry 200, example difference calculator circuitry 202, example frequency adjustment circuitry 204, and example change detection circuitry 206. The example frequency identification circuitry 200 identifies (e.g., detects, determines, etc.) frequencies associated with tasks. For example, the frequency identification circuitry 200 identifies frequencies (e.g., task frequencies) associated with tasks executed by the computing device 102 and/or the input devices 106. In some examples, the computing device 102 and/or the input devices 106 can include a camera. As such, the example frequency identification circuitry 200 identifies a frequency (e.g., task frequency) associated with a first task to capture video and a frequency associated with a second task to detect (e.g., identify) objects in the video. In some examples, a first one of the input devices 106 can be operatively coupled to a second one of the input devices 106. As such, the example frequency identification circuitry 200 identifies a frequency associated with a first task executed on the first one of the input devices 106 and a frequency associated with a second task executes on the second one of the input devices 106. In some examples, the example frequency identification circuitry 200 can be communicatively coupled to a power management unit (PMU), wherein the PMU can identify task frequencies associated with tasks executed by the device. In some examples, the computing device 102 can include a frequency (e.g., operating frequency, overall frequency, bus frequency, etc.) for executing tasks. In some examples, the overall frequency associated with the computing device 102 can be different from the task frequencies associated with the tasks executed by the computing device 102 and/or components of the computing device (e.g., peripheral devices, one or more processor circuits, one or more processor cores, graphical processing units (GPUs), etc.). Additionally or alternatively, ones of the input devices 106 can include a frequency (e.g., operating frequency, overall frequency, etc.) for executing tasks.

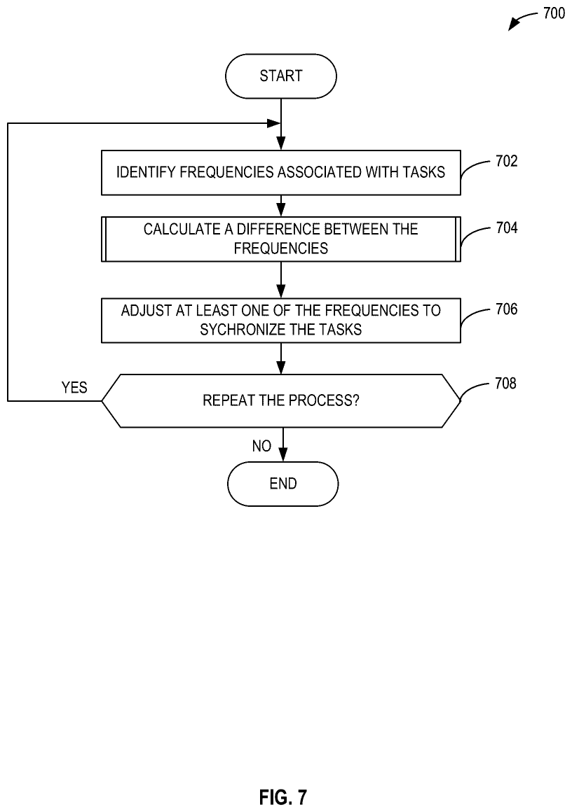

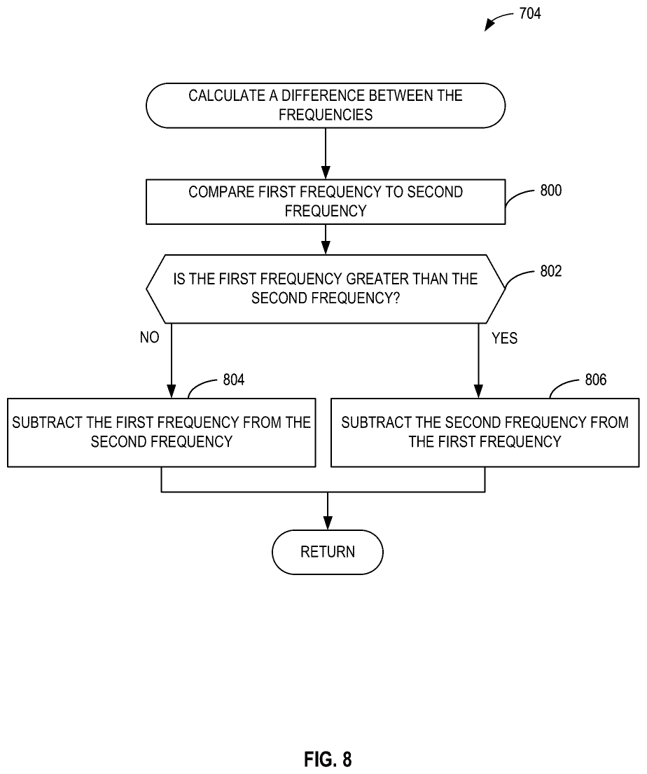

In some examples, the frequency identification circuitry 200 can identify tasks executing instructions for human hand keypoint detection or human activity detection. In other examples, the frequency identification circuitry 200 can identify tasks for generating messages in a publish-subscribe framework (e.g., interface). In some examples, the frequency identification circuitry 200 is instantiated by processor circuitry executing frequency identification instructions and/or configured to perform operations such as those represented by the flowcharts of FIGS. 7 and 8.

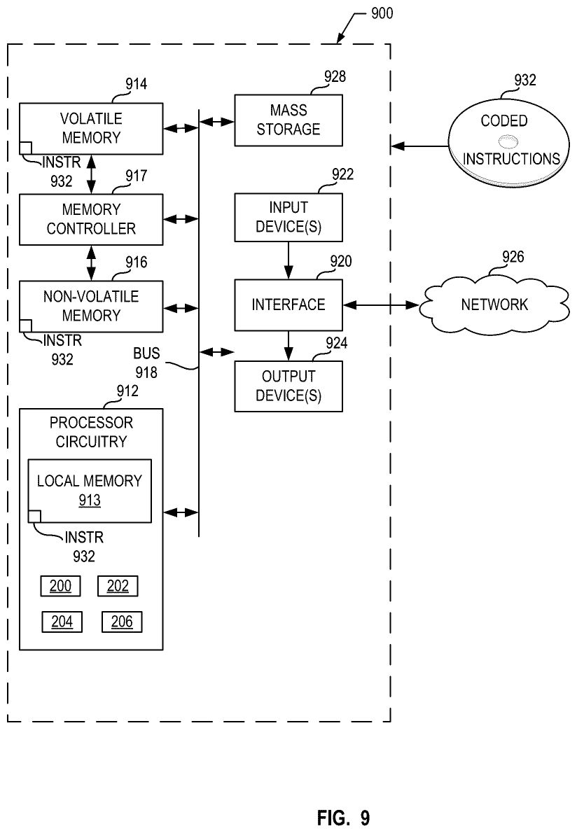

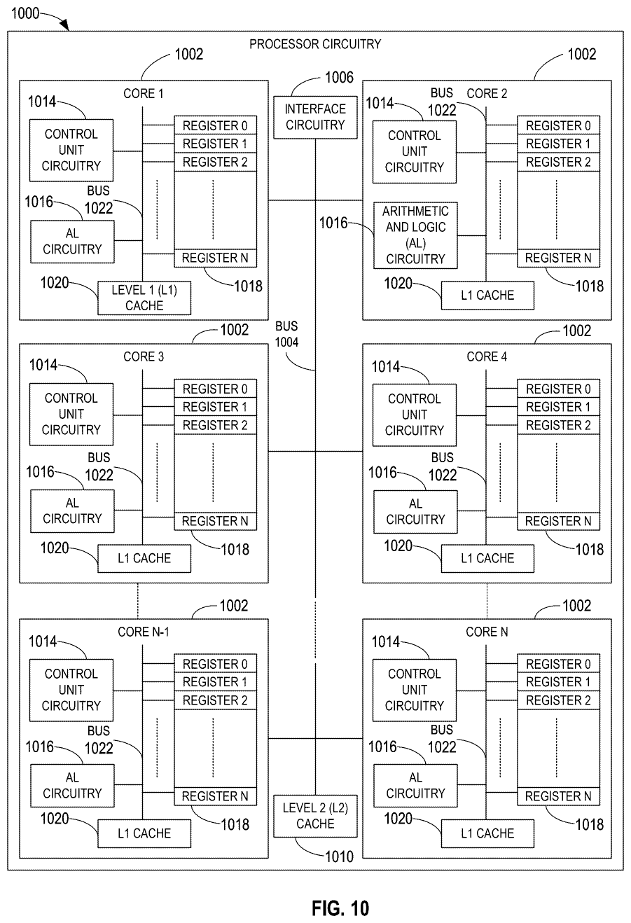

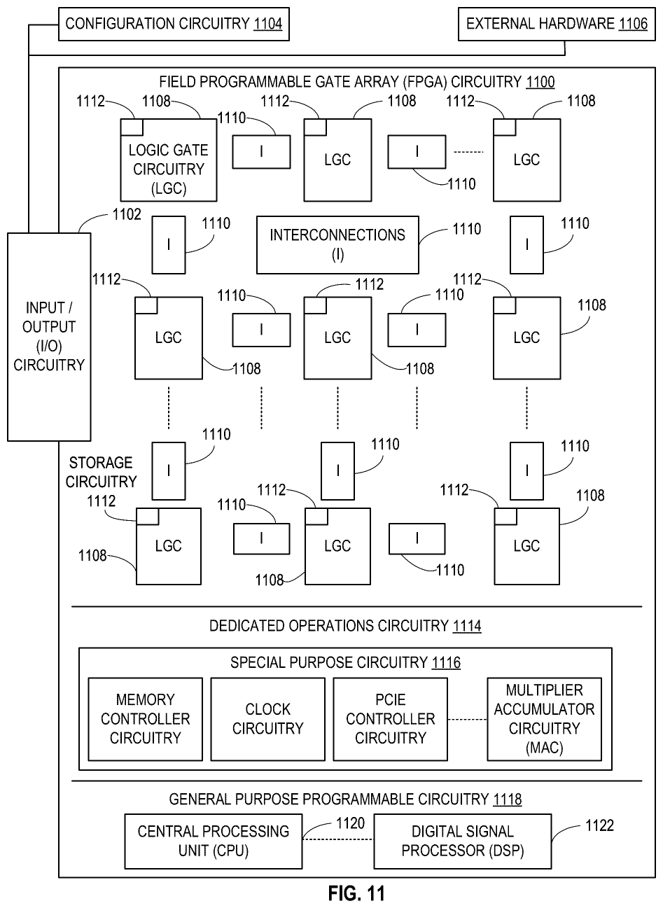

In some examples, the synchronization circuitry 110 includes means for identifying a frequency. For example, the means for identifying may be implemented by the frequency identification circuitry 200. In some examples, the frequency identification circuitry 200 may be instantiated by processor circuitry such as the example processor circuitry 912 of FIG. 9. For instance, the frequency identification circuitry 200 may be instantiated by the example microprocessor 1000 of FIG. 10 executing machine executable instructions such as those implemented by at least block 702 of FIG. 7. In some examples, the frequency identification circuitry 200 may be instantiated by hardware logic circuitry, which may be implemented by an ASIC, XPU, or the FPGA circuitry 1100 of FIG. 11 structured to perform operations corresponding to the machine readable instructions. Additionally or alternatively, the frequency identification circuitry 200 may be instantiated by any other combination of hardware, software, and/or firmware. For example, the frequency identification circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example difference calculator circuitry 202 calculates (e.g., determines) differences between a first frequency associated with a first task and a second frequency associated with a second task. In some examples, the difference calculator circuitry 202 determines differences between frequencies based on a comparison between a first frequency and a second frequency. For example, the difference calculator circuitry 202 determines whether the first frequency is greater than the second frequency. In some examples, the difference calculator circuitry 202 can calculate a difference between a first frequency and a second frequency when the second frequency is different from the first frequency. For example, if a first frequency is 5 Hertz (Hz) and a second frequency is 1 (Hz), then the example difference calculator circuitry 202 calculates a difference (e.g., 5 Hz−1 Hz=4 Hz) between the first frequency and the second frequency. In some examples, the difference calculator circuitry 202 is instantiated by processor circuitry executing difference calculator instructions and/or configured to perform operations such as those represented by the flowcharts of FIGS. 7 and 8.

In some examples, the synchronization circuitry 110 includes means for calculating a difference. For example, the means for calculating may be implemented by the difference calculator circuitry 202. In some examples, the difference calculator circuitry 202 may be instantiated by processor circuitry such as the example processor circuitry 912 of FIG. 9. For instance, the difference calculator circuitry 202 may be instantiated by the example microprocessor 1000 of FIG. 10 executing machine executable instructions such as those implemented by at least blocks 704 of FIG. 7 and blocks 800, 802, 804, 806 of FIG. 8. In some examples, the difference calculator circuitry 202 may be instantiated by hardware logic circuitry, which may be implemented by an ASIC, XPU, or the FPGA circuitry 1100 of FIG. 11 structured to perform operations corresponding to the machine readable instructions. Additionally or alternatively, the difference calculator circuitry 202 may be instantiated by any other combination of hardware, software, and/or firmware. For example, the difference calculator circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example frequency adjustment circuitry 204 adjusts (e.g., changes, increases, decreases, etc.) a frequency associated with a task such that the task operates in synchronization with another task. In some examples, the frequency adjustment circuitry 204 adjusts at least one of the frequencies based on the difference between the frequencies. For example, if the second frequency (e.g., 5 Hz) is greater than the first frequency (e.g., 1 Hz), the frequency adjustment circuitry 204 can decrease the second frequency. Further, the frequency adjustment circuitry 204 can decrease the second frequency from 5 Hz to 1 Hz, such that the first frequency (e.g., times of the first task) match the second frequency (e.g., times of the second task). In some examples, the frequency adjustment circuitry 204 adjusts the second frequency by delaying times of the second task. In other examples, the frequency adjustment circuitry 204 adjusts the second frequency by increasing a number of time units between ones of the second times of the second tasks. In some examples, the frequency adjustment circuitry 204 is instantiated by processor circuitry executing difference calculator instructions and/or configured to perform operations such as those represented by the flowchart of FIG. 7.

In some examples, the synchronization circuitry 110 includes means for adjusting at least one of the frequencies. For example, the means for adjusting may be implemented by the frequency adjustment circuitry 204. In some examples, the frequency adjustment circuitry 204 may be instantiated by processor circuitry such as the example processor circuitry 912 of FIG. 9. For instance, the frequency adjustment circuitry 204 may be instantiated by the example microprocessor 1000 of FIG. 10 executing machine executable instructions such as those implemented by at least block 706 of FIG. 7. In some examples, the frequency adjustment circuitry 204 may be instantiated by hardware logic circuitry, which may be implemented by an ASIC, XPU, or the FPGA circuitry 1100 of FIG. 11 structured to perform operations corresponding to the machine readable instructions. Additionally or alternatively, the frequency adjustment circuitry 204 may be instantiated by any other combination of hardware, software, and/or firmware. For example, the frequency adjustment circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example change detection circuitry 206 detects a change in a frequency associated with a task when the load conditions of a program increases and/or decreases. In some examples, the change detection circuitry 206 detects a change in at least one of the frequencies associated with the computing device 102 and/or the input devices 106. In some examples, the change detection circuitry 206 is instantiated by processor circuitry executing change detection instructions and/or configured to perform operations such as those represented by the flowchart of FIG. 7.

In some examples, the synchronization circuitry 110 includes means for detecting a change in at least one of the frequencies. For example, the means for detecting may be implemented by the change detection circuitry 206. In some examples, the change detection circuitry 206 may be instantiated by processor circuitry such as the example processor circuitry 912 of FIG. 9. For instance, the change detection circuitry 206 may be instantiated by the example microprocessor 1000 of FIG. 10 executing machine executable instructions such as those implemented by at least block 708 of FIG. 7. In some examples, the change detection circuitry 206 may be instantiated by hardware logic circuitry, which may be implemented by an ASIC, XPU, or the FPGA circuitry 1100 of FIG. 11 structured to perform operations corresponding to the machine readable instructions. Additionally or alternatively, the change detection circuitry 206 may be instantiated by any other combination of hardware, software, and/or firmware. For example, the change detection circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

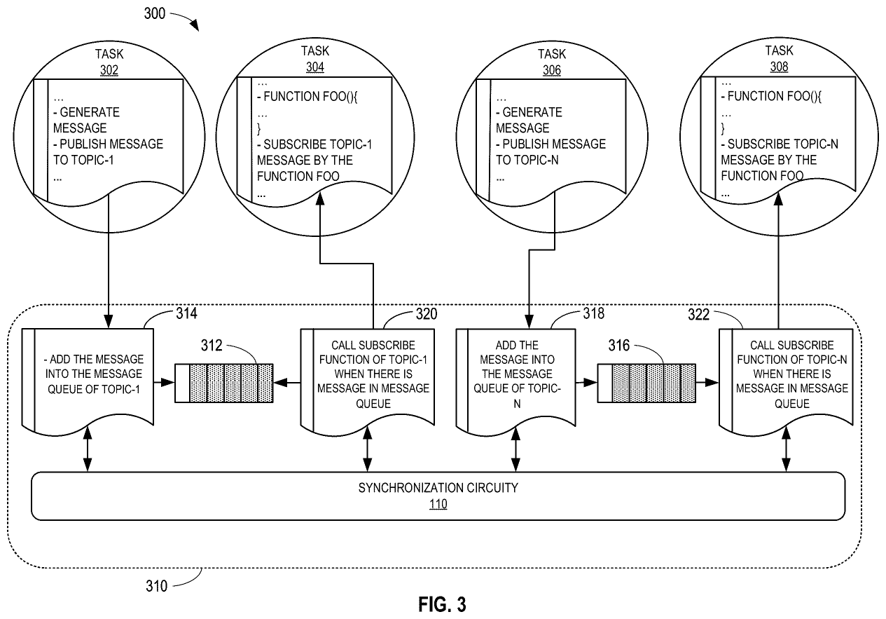

FIG. 3 is an example process flow 300 that may be used to implement the system 100 of FIG. 1. The example process flow 300 includes example tasks 302, 304, 306, 308, an example publish-subscribe framework 310, and the example synchronization circuitry 110. The example tasks 302, 304, 306, 308 can be generated by an example computing device (e.g., the computing device 102). In the example of FIG. 3, task 302 (e.g., message 302) is added (e.g., sent/transmitted) to a message queue 312 (e.g., a first message queue) in the publish-subscribe framework 310. The example task 302 can be added to the message queue 312 via a function 314 (e.g., programming function, code, an API call, etc.) executed by its corresponding device (e.g., one of input devices 106). Further, task 306 (e.g., message 306) is added to a message queue 316 (e.g., a second message queue) in the publish-subscribe framework 310. The example task 306 can be added to the message queue 316 via a function 318. As shown in the example of FIG. 3, the task 302 is associated with a first topic (e.g., Topic-1) and the task 306 is associated with an nth topic (e.g., Topic-N). Accordingly, the message queue 312 is associated with the Topic-1 and the message queue 316 is associated with the Topic-N. In examples disclosed herein, message queues (e.g., the message queues 312, 316) are storage locations for accumulated tasks. Further, message queues can denote (e.g., indicate) frequencies associated with the stored tasks. For example, the message queues 312, 316 include six boxes. The six boxes represent a timeline of one second. For example, the first box represents t=0 seconds, the second box represents t=0.2 seconds, the third box represents t=0.4 seconds, the fourth box represents t=0.6 seconds, the fifth box represents t=0.8 seconds, and the sixth box represents t=1 second. A shaded box indicates a message was sent at that time. For example, the message queue 312 includes five shaded boxes. As such, five messages are stored in the message queue 312 for each second and the frequency associated with the task 302 is 5 Hz (e.g., five messages per second=5 Hz). Additionally, the message queue 316 includes 5 shaded boxes indicating that five messages are stored in the message queue 316 for each second. As such, the frequency associated with the task 306 is 5 Hz.

In the example of FIG. 3, the publish-subscribe framework 310 accesses (e.g., checks) the message queues 312, 316 for available (e.g., present, new, etc.) messages. In this example, the message 302 is stored in the message queue 312. As such, the publish-subscribe framework 310 can run (e.g., call) a function 320 to execute (e.g., instantiates) the task 304 (e.g., message 304) associated with Topic-1. Further, the message 306 is stored in the message queue 316. As such, the publish-subscribe framework 310 can run a function 322 to generate the task 308 (e.g., message 308) associated with Topic-N.

In FIG. 3, the example synchronization circuitry 110 synchronizes tasks 302, 306 such that tasks 304, 308 can be generated at generally the same time. For example, task 302 can generate (e.g., output) the task 304 at a first frequency (e.g., 5 Hz) and the task 306 can generate the task 308 at a second frequency different from the first frequency (e.g., 1 Hz). In some examples, devices and/or programs may need the tasks 306, 308 to execute at substantially the same frequency. For example, in autonomous vehicles and robotic surgery, synchronized task execution can ensure safety. In some examples, the synchronization circuitry 110 can access (e.g., record, identify, etc.) timestamps and/or sequential IDs associated with the tasks 302, 304, 306, 308. For example, the synchronization circuitry 110 can identify first times indicative of times the task 302 sent messages and second times indicative of times the task 306 sent messages. In some examples, the synchronization circuitry 110 can identify first times corresponding to a first frequency of the task 304 and second times corresponding to a second frequency of the task 308. Additionally or alternatively, the example synchronization circuitry 110 can be communicatively coupled to a device clock (e.g., the clock 108 associated with the computing device 102).

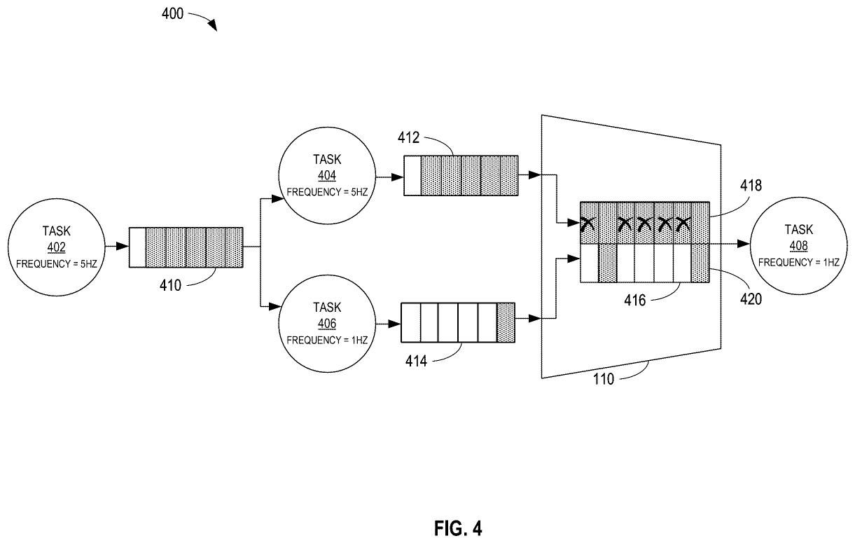

FIG. 4 illustrates an example process flow 400 to synchronize tasks. The example process 400 includes tasks 402, 404, 406, 408. In the example of FIG. 4, the task 402 is the input task and the task 408 is the output task. Accordingly, tasks 404, 406 are intermediate tasks. The example process 400 includes message queues 410, 412, 414, 416 and the synchronization circuitry 110.

The example synchronization circuitry 110 identifies frequencies associated with the tasks 402, 404, 406, 408. As shown in FIG. 4, an example computing device (e.g., the computing device 102) can execute the task 402 at a frequency of 5 Hz. In other words, the example computing device 102 executes the task 402 such that five messages are stored in the message queue 410 for each second. Accordingly, the message queue 410 includes five shaded boxes corresponding to each of the five messages generated per second. The example task 402 initiates (e.g., generates instructions for) the tasks 404, 406. In some examples, the task 402 initiates the tasks 404, 406 substantially simultaneously (e.g., within 0.2 seconds). The example computing device 102 can execute the task 404 at a frequency of 5 Hz and the task 406 at a frequency of 1 Hz. In other words, the example computing device 102 executes the task 404 such that five messages are stored in the message queue 412 for each second. Accordingly, the message queue 412 includes five shaded boxes corresponding to each of the five messages generated a second. Further, the example computing device 102 executes the task 406 such that one message is stored in the message queue 414 for each second. Accordingly, the message queue 414 includes one shaded box corresponding to the one message generated a second.

In the example of FIG. 4, the example message queue 416 includes messages associated with the task 404 and messages associated with the task 406. In particular, row 418 represents the frequency of the messages associated with the task 404 and row 420 represents the frequency of the messages associated with the task 406. In each of the rows 418, 420, the message queue 416 includes seven boxes. The seven boxes represent a timeline spanning 1.2 seconds. For example, the first box can represent t=0.8 seconds, the second box can represent t=1 second, the third box can represent t=1.2 seconds, the fourth box can represent t=1.4 seconds, the fifth box can represent t=1.6 seconds, the sixth box can represent t=1.8 second, and the seventh box can represent t=2 seconds. A shaded box indicates a message was sent at that time and an unshaded box indicates that a message was not sent at that time. In the example process flow 400, unsynchronized messages between the task 404 and the task 406 are indicated by an “X” in the message queue 416. For example, only messages for the task 404 occur at times t=0.8, t=1.2, t=1.4, t=1.6, and t=1.8. Accordingly, an “X” in the row 418 at times t=8, t=1.2, t=1.4, t=1.6, and t=1.8 indicate unsynchronized messages between the task 404 and the task 406. However, messages for the task 404 and the task 406 occur at times t=1 and t=2. Accordingly, the messages at times t=1 and t=2 are synchronized messages between the task 404 and the task 406.

Instead of deleting (e.g., skipping) the unsynchronized messages at times t=0.8, t=1.2, t=1.4, t=1.6, and t=1.8, examples disclosed herein can adjust (e.g., delay) the frequency associated with the task 404 such that messages associated with the task 404 align (e.g., sync, match, etc.) with messages associated with the task 406. In some examples, devices and/or programs may need the tasks 402, 404, 406 to execute at substantially the same frequency. For example, in autonomous vehicles and robotic surgery, synchronized task execution can ensure safety. In other examples, synchronized tasks can improve the performance of a device and/or an application.

In the example of FIG. 4, the task 408 is the output task. In this example, the synchronization circuitry 110 synchronizes the tasks 404, 406. In some examples, the frequency identification circuitry 200 accesses (e.g., identifies) the frequencies associated with the tasks 404, 406 in the message queue 416. The example difference calculator circuitry 202 can compare the frequency associated with the task 404 to the frequency associated with the task 406. In particular, the difference calculator circuitry 202 can determine which of the frequencies of the tasks 404, 406 is the largest (e.g., greatest). In this example, the frequency associated with the task 404 is greater than the frequency associated with the task 406. Accordingly, the example difference calculator circuitry subtracts the frequency associated with the task 406 from the frequency associated with the task 404 (e.g., 5 Hz−1 Hz=4 Hz).

The example frequency adjustment circuitry 204 adjusts the frequency associated with at least one of the tasks 404, 406. In this example, the example frequency adjustment circuitry 204 adjusts the frequency associated with the task 404 based on the frequency of task 404 being greater than the frequency of the task 406 (e.g., 5 Hz>1 Hz). The example frequency adjustment circuitry 204 can delay the task 404 such that the task 404 is associated with an adjusted frequency of 1 Hz. For example, the frequency adjustment circuitry 204 can delay the frequency associated with the task 404 based on the difference between the frequencies (e.g., 4 Hz). The example frequency adjustment circuitry 204 delays the frequency associated with the task 404 such that the adjusted frequency associated with the task 404 is 1 Hz (e.g., 5 Hz−4 Hz=1 Hz). Accordingly, the example frequency adjustment circuitry 204 maintains the tasks 404, 406 such that the frequencies associated with the tasks 404, 406 are substantially the same. Additionally, the synchronized tasks 404, 406 initiate the output task 408 such that the output task 408 generates messages at a frequency of 1 Hz.

In some examples, the frequencies associated with at least of the tasks 402, 404, 406 can change. For example, a greater data load can result in a change in the frequency associated with the task 404. The example change detection circuitry 206 can detect a change in the frequency associated with the task 404. Accordingly, the example frequency adjustment circuitry 204 can alter (e.g., change, adjust, etc.) the adjusted frequency associated with the task 404. In some examples, the frequency adjustment circuitry 204 can also adjust the frequency associated with the input task 402.

In some examples, the synchronization circuitry 110 can determine frequency ratios between the tasks 402, 404, 406, 408. For example, a first ratio between the frequency of the task 402 and the frequency of the task 404 can be 1:1 (e.g., 5 Hz:5 Hz=1:1). Additionally, a second ratio between the frequency of the task 402 and the frequency of the task 406 can be 1:5 (e.g., 1 Hz:5 Hz=1:5). A third example ratio between the frequency of the task 404 and the frequency of the task 408 can be 5:1 (e.g., 5 Hz:1 Hz=5:1). A fourth example ratio between the frequency of the task 406 and the frequency of the task 408 can be 1:1 (e.g., 1 Hz:1 Hz=1:1). In some examples, the synchronization circuitry 110 can synchronize the tasks 402, 404, 406, 408 such that the first, second, third, and fourth ratios are substantially the same (e.g., equal, within 0.2 seconds, etc.). In some examples, the frequency adjustment circuitry 204 adjusts at least one frequency associated with a ratio that is greater than 1.

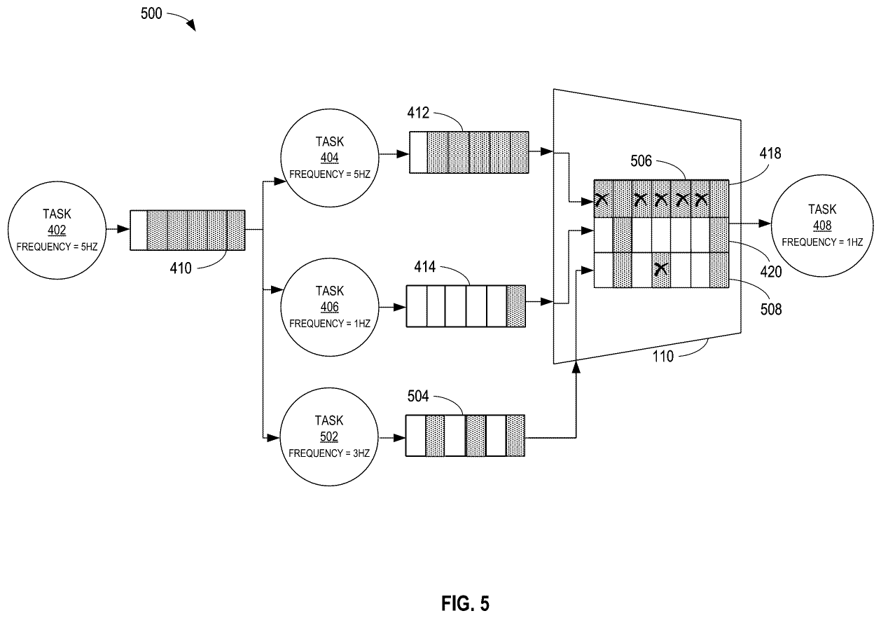

FIG. 5 illustrates an example process flow 500 to synchronize tasks. The example process flow 500 of FIG. 5 is similar to the example process flow 400 of FIG. 4, but, instead, includes example task 502, example message queue 504, and example message queue 506. In the example of FIG. 5, the task 402 initiates the tasks 404, 406, 502. In some examples, the task 402 initiates the tasks 404, 406, 502 substantially simultaneously. The example computing device 102 executes the task 502 at a frequency of 3 Hz. In other words, the example computing device 102 executes the task 502 such that three messages are stored in the message queue 504 for each second.

The example message queue 506 of FIG. 5 is similar to the example message queue 416 of FIG. 4, but, instead the message queue 506 includes row 508 to represent the frequency of the messages associated with the task 502. In the example process flow 500, unsynchronized messages between the tasks 404, 406, 502 are indicated by an “X” in the message queue 506. For example, only messages for the task 404 occur at times t=0.8, t=1.2, t=1.6, and t=1.8. Accordingly, an “X” in the row 418 at times t=0.8, t=1.2, t=1.6, and t=1.8 indicates unsynchronized messages between the tasks 404, 406, 502. Additionally, a message for the task 404 and a message for the task 502 occur at time t=1.4, but there is no message for the task 406 at time t=1.4. As such, an “X” in the row 418 a time t=1.4 and an “X” in the row 508 at the time t=1.4 indicate unsynchronized messages between the tasks 404, 406, 502. Messages for the tasks 404, 406, 502 occur at times t=1 and t=2. Accordingly, the messages at times t=1 and t=2 are synchronized messages between the tasks 404, 406, 502.

Instead of deleting the unsynchronized messages at times t=0.8, t=1.2, t=1.4, t=1.6, and t=1.8, examples disclosed herein can adjust the frequency associated with the tasks 404, 502 such that messages associated with the tasks 404, 502 align with messages associated with the task 406. In some examples, devices and/or programs may need the tasks 402, 404, 406, 502 to execute at substantially the same frequency. For example, in autonomous vehicles and robotic surgery, synchronized task execution can ensure safety. In other examples, synchronized tasks can improve the performance of a device and/or an application.

In this example, the synchronization circuitry 110 synchronizes the tasks 404, 406, 502. In some examples, the frequency identification circuitry 200 accesses (e.g., identifies) the frequencies associated with the tasks 404, 406, 502 in the message queue 506. The example difference calculator circuitry 202 can determine differences between the frequencies associated with the tasks 404, 406, 502. For example, the difference calculator circuitry 202 subtracts the frequency associated with the task 406 from the frequency associated with the task 502 (e.g., 3 Hz−1 Hz=2 Hz) based on the frequency associated with the task 502 being greater than the frequency associated with the task 502. The example frequency adjustment circuitry 204 adjusts the frequency associated with at least one of the tasks 404, 406, 502. In this example, the example frequency adjustment circuitry 204 adjusts the frequency associated with the task 404 based the difference between the frequencies of the tasks 404, 406. Additionally, the example frequency adjustment circuitry 204 adjusts the frequency associated with the task 502 based on the difference between the frequencies associated with the tasks 406, 404. As such, the frequency adjustment circuitry 204 delays the frequency associated with the task 502 such that the adjusted frequency associated with the task 502 is 1 Hz (e.g., 3 Hz−2 Hz=1 Hz). Accordingly, the example frequency adjustment circuitry 204 maintains the tasks 404, 406, 502 such that the frequencies associated with the tasks 404, 406, 502 are substantially the same. Additionally, the synchronized tasks 404, 406, 502 initiate the output task 408 such that the output task 408 generates messages at a frequency of 1 Hz. In some examples, the frequency adjustment circuitry 204 can also adjust the frequency associated with the input task 402.

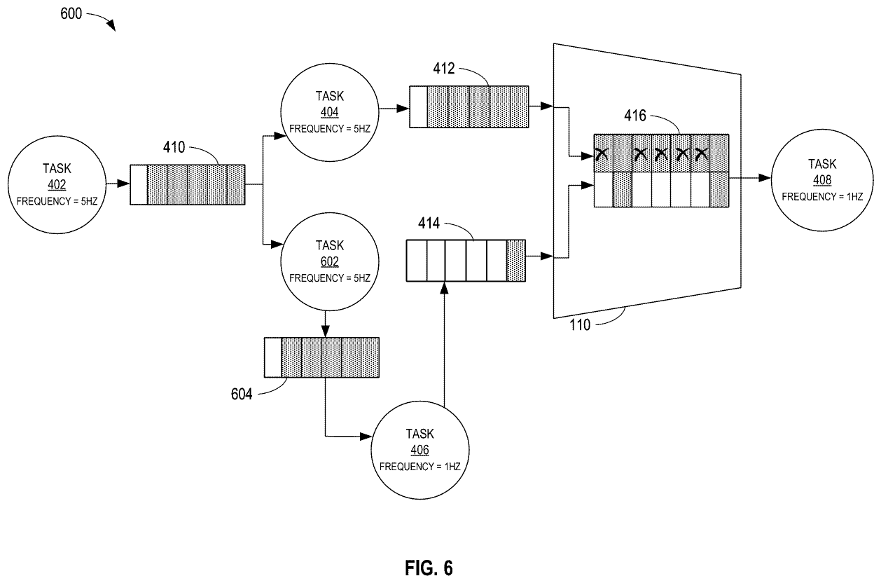

FIG. 6 illustrates an example process flow 600 to synchronize tasks. The example process flow 600 of FIG. 6 is similar to the example process flow 400 of FIG. 4, but, instead, includes example task 602 and example message queue 604. In the example of FIG. 6, the task 402 initiates the tasks 404, 602. In some examples, the task 402 initiates the tasks 404, 602 substantially simultaneously. The task 602 initiates the task 406. The example computing device 102 executes the task 602 at a frequency of 5 Hz. In other words, the example computing device 102 executes the task 602 such that five messages are stored in the message queue 604 for each second.

In the example process flow 400, unsynchronized messages between the task 404 and the task 406 are indicated by an “X” in the message queue 416. For example, only messages for the task 404 occur at times t=0.8, t=1.2, t=1.4, t=1.6, and t=1.8. Accordingly, an “X” in the row 418 at times t=0.8, t=1.2, t=1.4, t=1.6, and t=1.8 indicate unsynchronized messages between the task 404 and the task 406. However, messages for the task 404 and the task 406 occur at times t=1 and t=2. Accordingly, the messages at times t=1 and t=2 are synchronized messages between the task 404 and the task 406.

Instead of deleting the unsynchronized messages at times t=0.8, t=1.2, t=1.4, t=1.6, and t=1.8, examples disclosed herein can adjust the frequency associated with the task 404 such that messages associated with the task 404 align with messages associated with the task 406. In some examples, devices and/or programs may need the tasks 402, 404, 406 to execute a substantially the same frequency. For example, in autonomous vehicles and robotic surgery, synchronized task execution can ensure safety. In other examples, synchronized tasks can improve the performance of a device and/or an application.

In this example, the synchronization circuitry 110 synchronizes the tasks 404, 406, 602. The example difference calculator circuitry 202 can determine differences between the frequencies associated with the tasks 404, 406, 602. For example, the difference calculator circuitry 202 subtracts the frequency associated with the task 406 from the frequency associated with the task 602 (e.g., 5 Hz−1 Hz=4 Hz) based on the frequency associated with the task 602 being greater than the frequency associated with the task 406. The example frequency adjustment circuitry 204 adjusts the frequency associated with at least one of the tasks 404, 406, 602. In this example, the example frequency adjustment circuitry 204 adjusts the frequency associated with the tasks 404, 602 based on the frequency of task 404, 602 being greater than the frequency of the task 406 (e.g., 5 Hz>1 Hz).

The example frequency adjustment circuitry 204 adjusts the frequency associated with the task 602 based on the difference between the frequencies associated with the tasks 406, 602. As such, the frequency adjustment circuitry 204 delays the frequency associated with the task 602 such that the adjusted frequency associated with the task 602 is 1 Hz (e.g., 5 Hz−4 Hz=1 Hz). Accordingly, the example frequency adjustment circuitry 204 maintains the tasks 404, 406, 602 such that the frequencies associated with the tasks 404, 406, 602 are substantially the same. Additionally, the synchronized tasks 404, 406, 602 initiate the output task 408 such that the output task 408 generates messages at a frequency of 1 Hz. In some examples, the frequency adjustment circuitry 204 can also adjust the frequency associated with the input task 402.

While an example manner of implementing the synchronization circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example frequency identification circuitry 200, the example difference calculator circuitry 202, the example frequency adjustment circuitry 204, the example change detection circuitry 206, and/or, more generally, the example synchronization circuitry 110 of FIG. 1, may be implemented by hardware alone or by hardware in combination with software and/or firmware. Thus, for example, any of the example frequency identification circuitry 200, the example difference calculator circuitry 202, the example frequency adjustment circuitry 204, the example change detection circuitry 206, and/or, more generally, the example synchronization circuitry 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example synchronization circuitry 110 of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the synchronization circuitry 110 of FIG. 2, is shown in FIGS. 7 and 8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7 and 8, many other methods of implementing the example synchronization circuitry 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B.

Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to synchronize tasks. The machine readable instructions and/or the operations 700 of FIG. 7 begin at block 702, at which the frequency identification circuitry 200 identifies frequencies associated with tasks. For example, the frequency identification circuitry 200 identifies frequencies associated with tasks executed by the computing device 102 and/or the input devices 106. In some examples, a first one of the input devices 106 can be operatively coupled to a second one of the input devices 106. As such, the example frequency identification circuitry 200 identifies a frequency associated with a first task executed on the first one of the input devices 106 and a frequency associated with a second task executes on the second one of the input devices 106. In some examples, the frequency identification circuitry 200 can identify tasks for generating messages in a publish-subscribe framework (e.g., interface).

At block 704, the example difference calculator circuitry 202 calculates (e.g., determines) a difference between the frequencies. Example instructions to calculate a difference between the frequencies at block 704 are described below in connection with FIG. 8.

At block 706, the example frequency adjustment circuitry 204 adjusts at least one of the frequencies. In some examples, the frequency adjustment circuitry 204 adjusts at least one of the frequencies based on the difference between the frequencies. For example, if the second frequency (e.g., 5 Hz) is greater than the first frequency (e.g., 1 Hz), the frequency adjustment circuitry 204 can decrease the second frequency. Further, the frequency adjustment circuitry 204 can decrease the second frequency from 5 Hz to 1 Hz, such that the first frequency (e.g., times of the first task) match the second frequency (e.g., times of the second task). In some examples, the frequency adjustment circuitry 204 adjusts the second frequency by delaying times of the second task. In other examples, the frequency adjustment circuitry 204 adjusts the second frequency by increasing a number of time units between ones of the second times of the second tasks.

At block 708, the example change detection circuitry 206 determines whether or not to repeat the process. In some examples, the change detection circuitry 206 determines that the process is to be repeated (block 708) when the change detection circuitry 206 detects a change in at least one of the frequencies. If the example change detection circuitry 206 detects a change in at least one of the frequencies, the process returns to block 702. Otherwise, the process ends.

FIG. 8 is a flowchart representative of example machine readable instructions and/or example operations that may be executed and/or instantiated by processor circuitry to implement the example difference calculator circuitry 202 to calculate a difference between the frequencies. The example instructions of FIG. 8 may be used to implement block 704 of FIG. 7. The example machine readable instructions and/or the operations of FIG. 8 begin at block 800, at which the example difference calculator circuitry 202 compares a first frequency to a second frequency. For example, the difference calculator circuitry compares the frequency associated with the task 404, 5 Hz, to the frequency associated with the task 406, 1 Hz.

At block 802, the difference calculator circuitry 202 determines whether the first frequency is greater than the second frequency. If the second frequency is greater than the first frequency, then the process proceed to block 804. If the first frequency is greater than the second frequency (e.g., 5 Hz>1 Hz), then the process proceeds to block 806.

At block 804, the example difference calculator circuitry 202 subtracts the first frequency from the second frequency.

At block 806, the example difference calculator circuitry 202 subtracts the second frequency from the first frequency (e.g., 5 Hz−1 Hz=4 Hz). Then, the process ends.

FIG. 9 is a block diagram of an example processor platform 900 structured to execute and/or instantiate the machine readable instructions and/or the operations of FIG. 7 and 8 to implement the synchronization circuitry 110 of FIG. 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example frequency identification circuitry 200, the example difference calculator circuitry 202, the example frequency adjustment circuitry 204, and the example change detection circuitry 206.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 7 and 8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 7 and 8 to effectively instantiate the synchronization circuitry 110 of FIG. 2 as logic circuits to perform the operations corresponding to those machine readable instructions. In some such examples, the synchronization circuitry 110 of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7 and 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 7 and 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 7 and 8. As such, the FPGA circuitry 1100 may be structured to effectively instantiate some or all of the machine readable instructions of the flowcharts of FIGS. 7 and 8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIG. 9 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIG. 9 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 7 and 8 may be executed by one or more of the cores 1002 of FIG. 10, a second portion of the machine readable instructions represented by the flowcharts of FIGS. 7 and 8. may be executed by the FPGA circuitry 1100 of FIG. 11, and/or a third portion of the machine readable instructions represented by the flowcharts of FIGS. 7 and 8 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

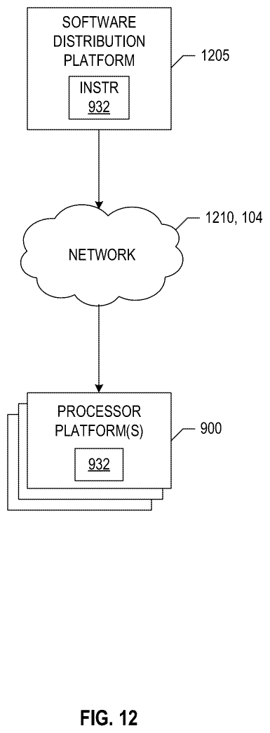

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7 and 8, as described above. The one or more servers of the example software distribution platform 1205 are in communication with an example network 1210, which may correspond to any one or more of the Internet and/or the example network 104 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7 and 8, may be downloaded to the example processor platform 900, which is to execute the machine readable instructions 932 to implement the synchronization circuitry 110. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that synchronize input message streams between devices and/or software programs. Examples disclosed herein monitor messages (e.g., message headers) for timestamps and/or sequential IDs to synchronize messages.

Examples disclosed herein adjust frequencies associated with messages, devices, programs, etc. As such, examples disclosed herein improve data management and power management of devices, software programs, AI systems, etc. Disclosed systems, methods, apparatus, and articles of manufacture improve the efficiency of using a computing device by synchronizing tasks. Disclosed systems, methods, apparatus, and articles of manufacture are accordingly directed to one or more improvement(s) in the operation of a machine such as a computer or other electronic and/or mechanical device.

Example 1 includes an apparatus to synchronize tasks executed by a computing device, the apparatus comprising at least one memory, machine readable instructions, and processor circuitry to at least one of instantiate or execute the machine readable instructions to identify a first task frequency associated with a first task, the first task executed by the computing device, the first task outputting first data at first times, identify a second task frequency associated with a second task, the second task executed by the computing device, the second task outputting second data at second times, when the second task frequency is different from the first task frequency, calculate a first difference between the second task frequency and the first task frequency, and adjust at least one of the first task frequency or the second task frequency based on the first difference such that the second times match the first times.

Example 2 includes the apparatus of example 1, wherein the computing device includes a camera, the first task executing instructions to capture video via the camera and the second task executing instructions to detect objects in the video.

Example 3 includes the apparatus of example 1, wherein the first task is executed by a graphics processing unit (GPU) associated with the computing device and the second task is executed by a video processing unit (VPU) associated with the computing device.

Example 4 includes the apparatus of example 1, wherein the computing device is a first computing device, the first computing device operatively coupled to a second computing device, the first task executing instructions via the first computing device, the second task executing instructions via the second computing device.

Example 5 includes the apparatus of example 1, wherein the computing device initiates the first task and the second task substantially simultaneously.

Example 6 includes the apparatus of example 1, wherein the computing device initiates the first task and the second task substantially sequentially.

Example 7 includes the apparatus of example 1, wherein the first task instantiates instructions to initiate the second task.

Example 8 includes the apparatus of example 1, wherein at least one of the first task or the second task executes instructions for human hand keypoint detection or human activity detection.

Example 9 includes the apparatus of example 1, wherein the first task includes generating first messages for a message queue of a publish-subscribe framework and the second task includes generating second messages for the message queue, the first messages associated with the first times, the second messages associated with the second times.

Example 10 includes the apparatus of example 9, wherein the computing device subscribes to the first messages and the second messages.

Example 11 includes the apparatus of example 1, wherein the processor circuitry is to adjust the second task frequency when the second task frequency is greater than the first task frequency.

Example 12 includes the apparatus of example 11, wherein the processor circuitry is to adjust the second task frequency by delaying ones of the second times.

Example 13 includes the apparatus of example 11, wherein the processor circuitry is to adjust the second task frequency by increasing a number of time units between ones of the second times.

Example 14 includes the apparatus of example 1, wherein the processor circuitry is to detect a change in the first task frequency, identify a changed task frequency associated with the first task, when the changed task frequency is different from the second task frequency, calculate a second difference between the changed task frequency and the second task frequency, and adjust at least one of the changed task frequency or the second task frequency based on the second difference such that the second times match the first times.

Example 15 includes the apparatus of example 14, wherein the processor circuitry is to adjust the changed task frequency when the changed task frequency is greater than the second task frequency.

Example 16 includes At least one non-transitory computer readable medium comprising instructions that, when executed, cause processor circuitry to at least identify a first task frequency associated with a first task, the first task executed by a computing device, the first task outputting first data at first times, identify a second task frequency associated with a second task, the second task executed by the computing device, the second task outputting second data at second times, when the second task frequency is different from the first task frequency, calculate a first difference between the second task frequency and the first task frequency, and adjust at least one of the first task frequency or the second task frequency based on the first difference such that the second times match the first times.

Example 17 includes the at least one non-transitory computer readable medium of example 16, wherein the computing device includes a camera, the first task executing instructions to capture video via the camera and the second task executing instructions to detect objects in the video.

Example 18 includes the at least one non-transitory computer readable medium of example 16, wherein the first task is executed by a graphics processing unit (GPU) associated with the computing device and the second task is executed by a video processing unit (VPU) associated with the computing device.

Example 19 includes the at least one non-transitory computer readable medium of example 16, wherein the computing device is a first computing device, the first computing device operatively coupled to a second computing device, the first task executing instructions via the first computing device, the second task executing instructions via the second computing device.

Example 20 includes the at least one non-transitory computer readable medium of example 16, wherein the computing device initiates the first task and the second task substantially simultaneously.

Example 21 includes the at least one non-transitory computer readable medium of example 16, wherein the computing device initiates the first task and the second task substantially sequentially.

Example 22 includes the at least one non-transitory computer readable medium of example 16, wherein the first task instantiates instructions to initiate the second task.

Example 23 includes the at least one non-transitory computer readable medium of example 16, wherein at least one of the first task or the second task executes instructions for human hand keypoint detection or human activity detection.

Example 24 includes the at least one non-transitory computer readable medium of example 16, wherein the first task includes generating first messages for a message queue of a publish-subscribe framework and the second task includes generating second messages for the message queue, the first messages associated with the first times, the second messages associated with the second times.

Example 25 includes the at least one non-transitory computer readable medium of example 24, wherein the computing device subscribes to the first messages and the second messages.

Example 26 includes the at least one non-transitory computer readable medium of example 16, wherein the processor circuitry is to adjust the second task frequency when the second task frequency is greater than the first task frequency.

Example 27 includes the at least one non-transitory computer readable medium of example 26, wherein the processor circuitry is to modify the second task frequency by delaying ones of the second times.

Example 28 includes the at least one non-transitory computer readable medium of example 26, wherein the processor circuitry is to modify the second task frequency by increasing a number of time units between ones of the second times.

Example 29 includes the at least one non-transitory computer readable medium of example 16, wherein the processor circuitry is to detect a change in the first task frequency, detect a changed task frequency associated with the first task, when the changed task frequency is different from the second task frequency, calculate a second difference between the changed task frequency and the second task frequency, and modify at least one of the changed task frequency or the second task frequency based on the second difference such that the second times match the first times.

Example 30 includes the at least one non-transitory computer readable medium of example 29, wherein the processor circuitry is to modify the changed task frequency when the changed task frequency is greater than the second task frequency.

Example 31 includes an apparatus to synchronize tasks executed by a computing device, the apparatus comprising means for identifying to identify a first task frequency associated with a first task, the first task executed by the computing device, the first task outputting first data at first times, identify a second task frequency associated with a second task, the second task executed by the computing device, the second task outputting second data at second times, when the second task frequency is different from the first task frequency, means for calculating to calculate a first difference between the second task frequency and the first task frequency, and means for adjusting to adjust at least one of the first task frequency or the second task frequency based on the first difference such that the second times match the first times.

Example 32 includes the apparatus of example 31, wherein the computing device includes a camera, the first task executing instructions to capture video via the camera and the second task executing instructions to detect objects in the video.

Example 33 includes the apparatus of example 31, wherein the first task is executed by a graphics processing unit (GPU) associated with the computing device and the second task is executed by a video processing unit (VPU) associated with the computing device.

Example 34 includes the apparatus of example 31, wherein the computing device is a first computing device, the first computing device operatively coupled to a second computing device, the first task executing instructions via the first computing device, the second task executing instructions via the second computing device.

Example 35 includes the apparatus of example 31, wherein the computing device initiates the first task and the second task substantially simultaneously.

Example 36 includes the apparatus of example 31, wherein the computing device initiates the first task and the second task substantially sequentially.

Example 37 includes the apparatus of example 31, wherein the first task instantiates instructions to initiate the second task.

Example 38 includes the apparatus of example 31, wherein at least one of the first task or the second task executes instructions for human hand keypoint detection or human activity detection.

Example 39 includes the apparatus of example 31, wherein the first task includes generating first messages for a message queue of a publish-subscribe framework and the second task includes generating second messages for the message queue, the first messages associated with the first times, the second messages associated with the second times.

Example 40 includes the apparatus of example 39, wherein the computing device subscribes to the first messages and the second messages.

Example 41 includes the apparatus of example 31, wherein the means for adjusting is to adjust the second task frequency when the second task frequency is greater than the first task frequency.

Example 42 includes the apparatus of example 41, wherein the means for adjusting is to adjust the second task frequency by delaying ones of the second times.

Example 43 includes the apparatus of example 41, wherein the means for adjusting is to adjust the second task frequency by increasing a number of time units between ones of the second times.

Example 44 includes the apparatus of example 31, further including means for detecting to detect a change in the first task frequency, the means for identifying to identify a changed task frequency associated with the first task, when the changed task frequency is different from the second task frequency, the means for calculating to calculate a second difference between the changed task frequency and the second task frequency, and the means for adjusting to adjust at least one of the changed task frequency or the second task frequency based on the second difference such that the second times match the first times.

Example 45 includes the apparatus of example 44, wherein the means for adjusting is to adjust the changed task frequency when the changed task frequency is greater than the second task frequency.

Example 46 includes a method to synchronize tasks executed by a computing device, the method comprising identifying a first task frequency associated with a first task, the first task executed by the computing device, the first task outputting first data at first times, identifying a second task frequency associated with a second task, the second task executed by the computing device, the second task outputting second data at second times, when the second task frequency is different from the first task frequency, calculating a first difference between the second task frequency and the first task frequency, and adjusting at least one of the first task frequency or the second task frequency based on the first difference such that the second times match the first times.

Example 47 includes the method of example 46, wherein the computing device includes a camera, the first task executing instructions to capture video via the camera and the second task executing instructions to detect objects in the video.

Example 48 includes the method of example 46, wherein the first task is executed by a graphics processing unit (GPU) associated with the computing device and the second task is executed by a video processing unit (VPU) associated with the computing device.

Example 49 includes the method of example 46, wherein the computing device is a first computing device, the first computing device operatively coupled to a second computing device, the first task executing instructions via the first computing device, the second task executing instructions via the second computing device.

Example 50 includes the method of example 46, wherein the computing device initiates the first task and the second task substantially simultaneously.

Example 51 includes the method of example 46, wherein the computing device initiates the first task and the second task substantially sequentially.

Example 52 includes the method of example 46, wherein the first task instantiates instructions to initiate the second task.

Example 53 includes the method of example 46, wherein at least one of the first task or the second task executes instructions for human hand keypoint detection or human activity detection.

Example 54 includes the method of example 46, wherein the first task includes generating first messages for a message queue of a publish-subscribe framework and the second task includes generating second messages for the message queue, the first messages associated with the first times, the second messages associated with the second times.

Example 55 includes the method of example 54, wherein the computing device subscribes to the first messages and the second messages.

Example 56 includes the method of example 46, further including adjusting the second task frequency when the second task frequency is greater than the first task frequency.

Example 57 includes the method of example 56, further including adjusting the second task frequency by delaying ones of the second times.

Example 58 includes the method of example 56, further including adjusting the second task frequency by increasing a number of time units between ones of the second times.

Example 59 includes the method of example 46, further including detecting a change in the first task frequency, identifying a changed task frequency associated with the first task, when the changed task frequency is different from the second task frequency, calculating a second difference between the changed task frequency and the second task frequency, and adjusting at least one of the changed task frequency or the second task frequency based on the second difference such that the second times match the first times.

Example 60 includes the method of example 59, further including adjusting the changed task frequency when the changed task frequency is greater than the second task frequency.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
at least one processor circuit to be programmed by the machine readable instructions to:
identify a first task frequency associated with a first task, the first task to be executed by a compute device, the first task to output first data at first times;
identify a second task frequency associated with a second task, the second task to be executed by the compute device, the second task to output second data at second times;
based on the second task frequency being different from the first task frequency, calculate a first difference between the second task frequency and the first task frequency; and
adjust at least one of the first task frequency or the second task frequency based on the first difference such that the second times match the first times.

2. The apparatus of claim 1, wherein the compute device includes a camera, the first task includes capture of video via the camera, and the second task includes detection of an object in the video.

3. The apparatus of claim 1, wherein the first task is to be executed by a graphics processing unit (GPU) associated with the compute device and the second task is to be executed by a video processing unit (VPU) associated with the compute device.

4. The apparatus of claim 1, wherein the compute device includes a first compute device and a second compute device, the first compute device in communication with the second compute device, the first task to be executed by the first compute device, the second task to be executed by the second compute device.

5. The apparatus of claim 1, wherein the compute device is to initiate the first task and the second task substantially simultaneously.

6. The apparatus of claim 1, wherein the compute device is to initiate the first task and the second task substantially sequentially.

7. The apparatus of claim 1, wherein the first task includes instantiation of instantiates-instructions to initiate the second task.

8. The apparatus of claim 1, wherein at least one of the first task or the second task includes execution of instructions for at least one of human hand keypoint detection or human activity detection.

9. The apparatus of claim 1, wherein the first task includes generation of first messages for a message queue of a publish-subscribe framework and the second task includes generation of second messages for the message queue, the first messages associated with the first times, the second messages associated with the second times.

10. The apparatus of claim 9, wherein the compute device is to subscribe to the first messages and the second messages.

11. The apparatus of claim 1, wherein one or more of the at least one processor circuit is to adjust the second task frequency based on the second task frequency being greater than the first task frequency.

12. The apparatus of claim 11, wherein one or more of the at least one processor circuit is to delay ones of the second times to adjust the second task frequency.

13. The apparatus of claim 11, wherein one or more of the at least one processor circuit is to increase a number of time units between ones of the second times to adjust the second task frequency.

14. The apparatus of claim 1, wherein one or more of the at least one processor circuit is to:
detect a change in the first task frequency;
identify a changed task frequency associated with the first task;
based on the changed task frequency being different from the second task frequency, calculate a second difference between the changed task frequency and the second task frequency; and
adjust at least one of the changed task frequency or the second task frequency based on the second difference such that the second times match the first times.

15. The apparatus of claim 14, wherein one or more of the at least one processor circuit is to adjust the changed task frequency based on the changed task frequency being greater than the second task frequency.

16. At least one non-transitory computer readable medium comprising instructions that, when executed, cause at least one processor circuit to:
detect a first task frequency associated with a first task, the first task to be executed by a compute device, the first task to output first data at first times;
detect a second task frequency associated with a second task, the second task to be executed by the compute device, the second task to output second data at second times;
based on the second task frequency being different from the first task frequency, calculate a first difference between the second task frequency and the first task frequency; and
modify at least one of the first task frequency or the second task frequency based on the first difference such that the second times match the first times.

17. The at least one non-transitory computer readable medium of claim 16, wherein the compute device includes a camera, the first task includes capture of video via the camera, and the second task includes detection of an object in the video.

18. The at least one non-transitory computer readable medium of claim 16, wherein the first task is to be executed by a graphics processing unit (GPU) associated with the compute device and the second task is to be executed by a video processing unit (VPU) associated with the compute device.

19. (canceled)

20. An apparatus comprising:
means for identifying a first task frequency associated with a first task and a second task frequency associated with a second task, the first task and the second task to be executed by a compute device, the first task to output first data at first times the second task to output second data at second times;
means for calculating a first difference between the second task frequency and the first task frequency based on the second task frequency being different from the first task frequency; and
means for adjusting at least one of the first task frequency or the second task frequency based on the first difference such that the second times match the first times.

21. The apparatus of claim 20, wherein the compute device includes a camera, the first task includes capture of video via the camera, and the second task includes detection of an object in the video.

22.-25. (canceled)
